(19) United States
(12) Patent Application Publication
(10) Pub. No.: US 2024/0330586 A1
(43) Pub. Date: Oct. 3, 2024

(54) INFORMATION PROCESSING APPARATUS, INFORMATION PROCESSING METHOD, AND INFORMATION PROCESSING PROGRAM

(71) Applicant: FUJIFILM CORPORATION, Tokyo (JP)

(72) Inventors: Shotaro MISAWA, Tokyo (JP); Ryuji KANO, Tokyo (JP); Hirokazu YARIMIZU, Tokyo (JP); Tomoki TANIGUCHI, Tokyo (JP); Kohei ONODA, Tokyo (JP)

(21) Appl. No.: 18/589,436

(22) Filed: Feb. 28, 2024

(30) Foreign Application Priority Data
Mar. 31, 2023 (JP) 2023-058010

(51) Int. Cl. G06F 40/247

(52) U.S. Cl. CPC G06F 40/247

(57) ABSTRACT

An information processing apparatus acquires document data, and an item and a numerical value which are associated with each other, and extracts, in a case in which a second numerical value within an allowable range including an acquired first numerical value is included in the document data, a phrase existing around the second numerical value included in the document data as a candidate for a synonymous term of the item.

### CROSS-REFERENCE TO RELATED APPLICATIONS

This application claims priority from Japanese Patent Application No. 2023-058010, filed on Mar. 31, 2023, the entire disclosure of which is incorporated herein by reference.

### BACKGROUND

### 1. Technical Field

The present disclosure relates to an information processing apparatus, an information processing method, and an information processing program.

### 2. Description of the Related Art

JP2007-172315A discloses a technology of extracting a character string pattern common to a plurality of synonymous terms to generate a synonymous term dictionary.

### SUMMARY

In a case of extracting a pair of synonymous terms from the commonality of the character string patterns, it may not be possible to accurately extract the pair of synonymous terms.

The present disclosure has been made in view of the above circumstances, and the present disclosure is to provide an information processing apparatus, an information processing method, and an information processing program which can accurately extract a pair of synonymous terms.

The present disclosure relates to an information processing apparatus comprising: at least one processor, in which the processor acquires document data, and an item and a numerical value which are associated with each other, and extracts, in a case in which a second numerical value within an allowable range including an acquired first numerical value is included in the document data, a phrase existing around the second numerical value included in the document data as a candidate for a synonymous term of the item.

In addition, the present disclosure relates to an information processing method including: via a processor provided in an information processing apparatus, acquiring document data, and an item and a numerical value which are associated with each other; and extracting, in a case in which a second numerical value within an allowable range including an acquired first numerical value is included in the document data, a phrase existing around the second numerical value included in the document data as a candidate for a synonymous term of the item.

In addition, the present disclosure relates to an information processing program for causing a processor provided in an information processing apparatus to execute a process including: acquiring document data, and an item and a numerical value which are associated with each other; and extracting, in a case in which a second numerical value within an allowable range including an acquired first numerical value is included in the document data, a phrase existing around the second numerical value included in the document data as a candidate for a synonymous term of the item.

According to the present disclosure, it is possible to accurately extract the pair of synonymous terms.

### BRIEF DESCRIPTION OF THE DRAWINGS

FIG. 1 is a block diagram showing an example of a hardware configuration of an information processing apparatus.

FIG. 2 is a diagram showing an example of an examination result DB.

FIG. 3 is a block diagram showing an example of a functional configuration of the information processing apparatus.

FIG. 4 is a diagram for describing processing of extracting a synonymous term candidate.

FIG. 5 is a diagram for describing processing of extracting a synonymous term candidate according to a modification example.

FIG. 6 is a diagram for describing processing of generating a synonymous term list.

FIG. 7 is a diagram for describing weighting processing.

FIG. 8 is a diagram for describing the processing of extracting the synonymous term candidate according to the modification example.

FIG. 9 is a diagram for describing the processing of extracting the synonymous term candidate according to the modification example.

FIG. 10 is a flowchart showing an example of the processing of generating the synonymous term list.

### DETAILED DESCRIPTION

Hereinafter, with reference to the accompanying drawings, an embodiment for performing the technology of the present disclosure will be described in detail.

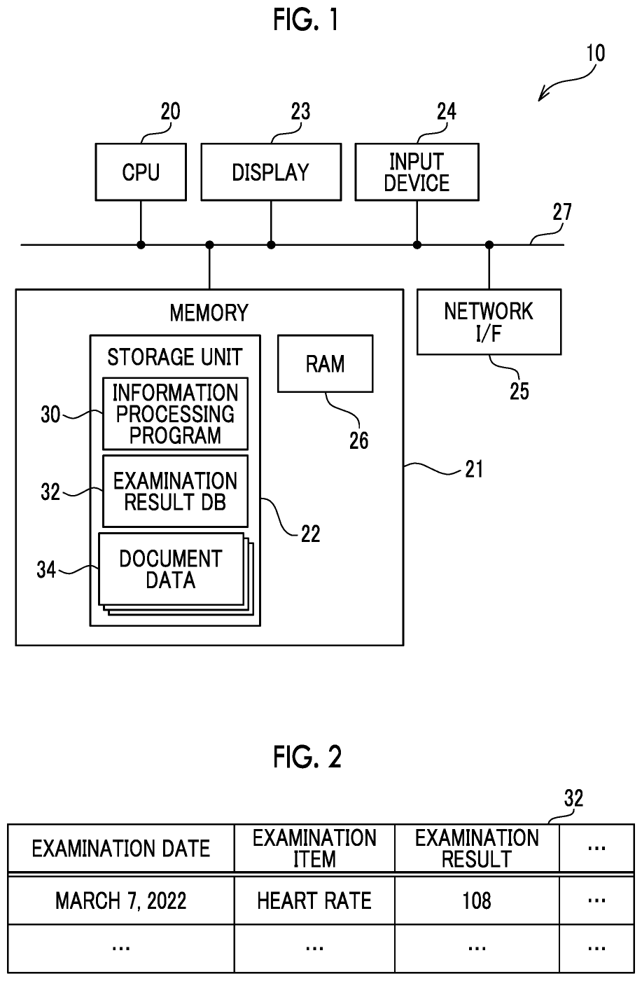

First, with reference to FIG. 1, a hardware configuration of an information processing apparatus 10 according to the present embodiment will be described. Examples of the information processing apparatus 10 include a computer, such as a personal computer or a server computer. As shown in FIG. 1, the information processing apparatus 10 includes a central processing unit (CPU) 20, a memory 21, a storage unit 22, a display 23, an input device 24, and a network interface (I/F) 25.

The CPU 20 realizes a functional configuration, which will be described below, by executing a program stored in the storage unit 22 described below. The CPU 20 is an example of a processor according to the technology of the present disclosure.

The memory 21 includes the storage unit 22 and a random access memory (RAM) 26. The RAM 26 is a memory for primary storage, and is, for example, a RAM, such as a static random access memory (SRAM) or a dynamic random access memory (DRAM).

The storage unit 22 is a non-volatile memory, and is realized by, for example, at least one of a hard disk drive (HDD), a solid state drive (SSD), or a flash memory. An information processing program 30 is stored in the storage unit 22 as a storage medium. The CPU 20 reads out the information processing program 30 from the storage unit 22, loads the readout information processing program 30 in the memory 21, and executes the loaded information processing program 30.

Further, the storage unit 22 stores an examination result DB 32 and a plurality of document data 34. As shown in FIG. 2, the examination result DB 32 stores an examination date, an examination item, and an examination result of an examination at a hospital in association with each other. The examination result represents a numerical value corresponding to the examination item. The examination item and the examination result are examples of an item and a numerical value which are associated with each other according to the technology of the present disclosure. A plurality of sets of the examination dates, the examination items, and the examination results are stored in the examination result DB 32. The examination result DB 32 is an example of accumulation data in which a plurality of sets of the items and the numerical values according to the technology of the present disclosure are accumulated. In the examination result DB 32, identification information of a patient as an examination target, such as a patient ID, may be further associated. The document data 34 according to the present embodiment is a medical document, such as an electronic medical record.

The display 23 is a device that displays various screens under the control of the CPU 20, and is, for example, a liquid crystal display or an electro luminescence (EL) display. The input device 24 is a device for a user to perform input, and is, for example, at least any of a keyboard, a mouse, a microphone for voice input, a touch pad for close contact input including contact, or a camera for gesture input. The network I/F 25 is an interface for connection to a network. A bus 27 connects the CPU 20, the memory 21, the storage unit 22, the display 23, the input device 24, and the network I/F 25 to each other.

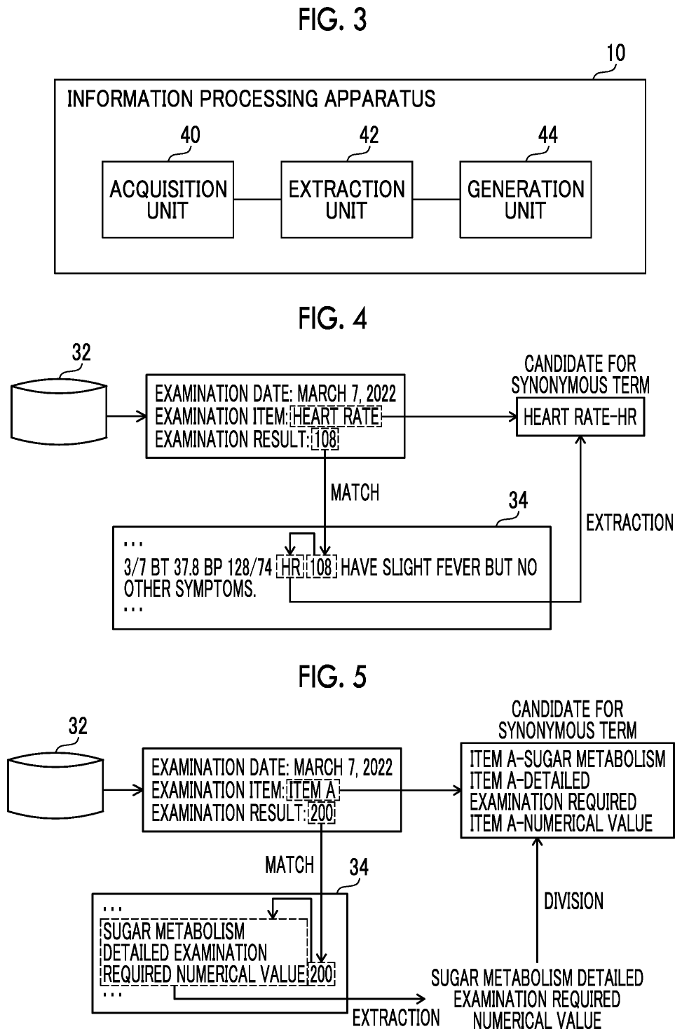

Hereinafter, with reference to FIG. 3, a functional configuration of the information processing apparatus 10 will be described. As shown in FIG. 3, the information processing apparatus 10 includes an acquisition unit 40, an extraction unit 42, and a generation unit 44. The CPU 20 executes the information processing program 30, thereby functioning as the acquisition unit 40, the extraction unit 42, and the generation unit 44.

As shown in FIG. 4, the acquisition unit 40 acquires the plurality of document data 34 from the storage unit 22, and acquires the examination item and the examination result which are associated with each other from the examination result DB 32. The acquisition unit 40 may sequentially acquire the examination item and the examination result from the examination result DB 32, or may acquire the examination item and the examination result which are designated by the user from the examination result DB 32.

As shown in FIG. 4, the extraction unit 42 determines whether the examination result acquired by the acquisition unit 40 is included in the plurality of document data 34 acquired by the acquisition unit 40. In a case in which the examination result is included in the document data 34, the extraction unit 42 extracts a phrase existing around the examination result included in the document data 34 as a candidate for a synonymous term of the examination item. In the present embodiment, the extraction unit 42 extracts a compound noun existing immediately before the examination result as the candidate for the synonymous term of the examination item. In the example in FIG. 4, an example is shown in which “examination item: heart rate” and “examination result: 108” are acquired from the examination result DB 32, and “HR” immediately before “108” in the document data 34 is extracted as the candidate for the synonymous term of “heart rate”. In this case, the extraction unit 42 may ignore the numerical value existing in the first half of the compound noun.

It should be noted that the extraction unit 42 may determine whether a second numerical value within an allowable range including a first numerical value indicated by the acquired examination result is included in the document data 34. Examples of the second numerical value in this case include a value in a range obtained by adding a margin to the first numerical value and a numerical value obtained by rounding off the first numerical value. In this case, in a case in which the second numerical value is included in the document data 34, the extraction unit 42 may extract a phrase existing around the second numerical value included in the document data 34 as the candidate for the synonymous term of the examination item.

In addition, the phrase as an extraction target by the extraction unit 42 is not limited to the phrase existing immediately before the examination result, but may be a phrase existing immediately after the examination result, or may be phrases existing immediately before and immediately after the examination result.

In addition, in a case of extracting the phrase existing around the examination result, the extraction unit 42 may extract a plurality of phrases having different lengths or positions as the candidates for the synonymous term. In this case, specifically, as shown in FIG. 5, in a case in which the number of characters in the phrase existing immediately before the examination result is equal to or larger than a certain value, the extraction unit 42 divides the phrase existing immediately before the examination result into the plurality of phrases having different lengths by a known technology, such as n-gram. Then, the extraction unit 42 sets each of the plurality of phrases obtained by division as the candidate for the synonymous term.

In addition, in this case, the extraction unit 42 may divide the phrase existing around the examination result at a position of the delimiter such as “/”, “:”, “(”, or “)” into the plurality of phrases.

The extraction unit 42 may only set, as the document data 34 of the extraction target of the phrase, the document data 34 described for the same patient as the examination item and the examination result among the plurality of document data 34. In addition, the extraction unit 42 may only set, as the document data 34 of the extraction target of the phrase, the document data 34 created after the examination date corresponding to the examination item and the examination result among the plurality of document data 34.

The generation unit 44 generates a synonymous term list from the candidates for the synonymous term based on a statistical value of the phrase extracted by the extraction unit 42 in the examination result DB 32. In the present embodiment, an example will be described in which the number of times of appearance of the phrase extracted by the extraction unit 42 in the examination result DB 32 is applied as the statistical value.

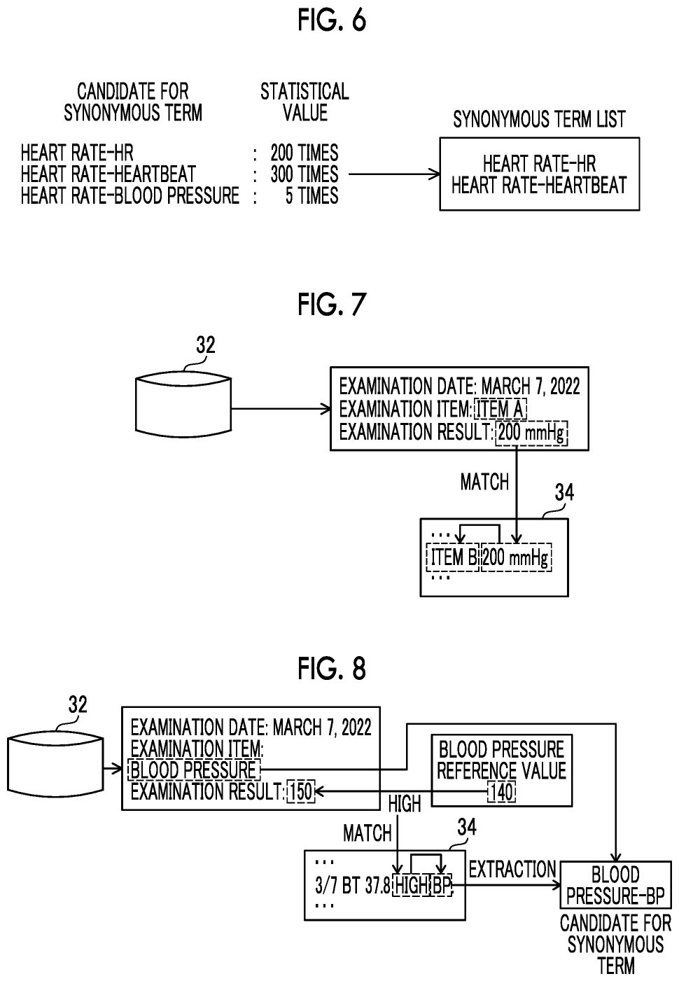

That is, as shown in FIG. 6, the generation unit 44 counts the number of times of appearance as the statistical value of the phrase extracted by the extraction unit 42 in the examination result DB 32. Then, the generation unit 44 generates the synonymous term list by adding the phrase of which the statistical value is equal to or larger than a threshold value among the phrases extracted by the extraction unit 42 to the synonymous term list. In FIG. 6, an example is shown in which “HR”, “heartbeat”, and “blood pressure” are extracted as the candidates for the synonymous term of “heart rate”, and “HR” and “heartbeat” of which the statistical value is equal to or larger than the threshold value (for example, 50) are added to the synonymous term list as the synonymous term of “heart rate”.

It should be noted that the generation unit 44 may add, to the synonymous term list, the phrase having a relatively large statistical value, such as “top ∘ cases” or “top ∘ %”, among the phrases extracted by the extraction unit 42.

In a case of deriving the statistical value, the generation unit 44 may refer to the plurality of document data 34 instead of the examination result DB 32, or may refer to both the examination result DB 32 and the plurality of document data 34. That is, the accumulation data in which the plurality of sets of the items and the numerical values are accumulated is not limited to data of a database format, and may be data of a text format, such as the document data 34. Specifically, the generation unit 44 may extract a combination of the item and the numerical value from the document data 34, such as an examination report, and may use the combination of the item and the numerical value to derive a statistical value of a combination of the item and the numerical value extracted from another document data 34.

In addition, the generation unit 44 may count the number of times of appearance in a specific period unit, such as a hospitalization period unit, in a case of counting the number of times of appearance. For example, in a case in which the same phrase is included in each of two document data 34 in the same hospitalization period, the generation unit 44 may count the number of times of appearance as one. Specifically, in a case in which “HR” is obtained as the candidate for the synonymous term from the two document data 34 in the same hospitalization period for each of the examination result “108” and the examination result “90” in which the examination item is “heart rate”, the generation unit 44 may count the number of times of appearance as one. It should be noted that the generation unit 44 may perform counting in a document data unit in a case of counting the number of times of appearance. That is, in a case in which the same combination of the examination item and the examination result is used a plurality of times in the same document data, the generation unit 44 may count the number of times of appearance of the combination as one.

In addition, in a case in which a set of the candidates having the same synonymous term is obtained for different examination results, the generation unit 44 may count only the number of times of appearance of the term, or may count the number of times of appearance of the set of the phrase and the examination result. Specifically, in a case in which “HR” is obtained as the candidate for the synonymous term for each of the examination result “108” and the examination result “90” in which the examination item is “heart rate”, the generation unit 44 may count the number of times of appearance as shown below. That is, in this case, the generation unit 44 may separately count the number of times of the appearance of “HR” corresponding to “108” and the number of times of the appearance of “HR” corresponding to “90”, or may count the numbers of times of appearance in total.

In addition, as shown in FIG. 7, the generation unit 44 may perform weighting by setting the weight coefficient of the statistical value of the phrase extracted by applying a unit to the examination result and including the numerical value and the unit corresponding to the examination result in the document data 34 to a value larger than the weight coefficient of the statistical value of the phrase extracted by including only the numerical value in the document data 34. In a case in which not only the numerical value but also the unit matches, it is considered that the possibility of the synonymous term is relatively high. Therefore, by performing this weighting, it is possible to accurately extract the pair of synonymous terms.

In addition, the generation unit 44 may perform weighting of the statistical value of the phrase extracted by the extraction unit 42 based on the statistical value of the examination result in the examination result DB 32. Specifically, for example, in a case in which “HR” is obtained as the candidate for the synonymous term for the examination result “108” in which the examination item is “heart rate”, the generation unit 44 counts the number of times of appearance of “108” as the statistical value of the examination result in the examination result DB 32. In this case, the generation unit 44 may reduce the weight coefficient of the statistical value of the phrase extracted by the extraction unit 42 as the number of times of appearance of the examination result increases. This is because it is considered that the numerical value is used more generally as the number of times of appearance of the examination result is larger. By reducing the weight coefficient of the phrase extracted based on the numerical value generally used, the pair of synonymous terms can be accurately extracted.

In addition, the generation unit 44 may derive a degree of similarity between the examination item acquired by the acquisition unit 40 and the phrase extracted by the extraction unit 42. Examples of the degree of similarity in this case include an editing distance and a Levenshtein distance. In this case, the generation unit 44 may perform weighting by setting the weight coefficient of the statistical value of the phrase of which the degree of similarity is equal to or larger than a certain value to a value larger than the weight coefficient of the statistical value of the phrase of which the degree of similarity is smaller than the certain value. As a result, for example, similar phrases, such as “heart rate” and “heartbeat”, are likely to be extracted as the pair of synonymous terms.

In addition, the generation unit 44 may increase the weight coefficient for the statistical value of the phrase extracted by the extraction unit 42 as the difference between the examination date on which the examination result is obtained in the examination result DB 32 and a creation date of the document data 34 is smaller.

In addition, in a case in which the same examination is performed a plurality of times for the same patient, the generation unit 44 may perform weighting by setting the weight coefficient of the statistical value of the phrase extracted from the document data 34 created after the relatively later examination date for the examination result of the relatively previous examination date the to a value smaller than the weight coefficient of the statistical value of the phrase extracted from the document data 34 created from the relatively previous examination date to the relatively later examination date. This is because, for example, in a case in which the first examination result is “90” and the second examination result is “130”, it is considered that the probability of “90” appearing in the document data 34 created after the second examination date is lower than the probability of “130” appearing.

As shown in FIG. 8, the acquisition unit 40 may further acquire a reference value corresponding to the examination item. The reference value in this case may be stored in the examination result DB 32 or may be stored in the storage unit 22. In this case, in a case in which a word corresponding to a magnitude relationship of the examination result acquired by the acquisition unit 40 with respect to the reference value is included in the document data 34, the extraction unit 42 may extract a phrase existing around the word included in the document data 34. In addition, in this case, the statistical value of the word may further include the statistical value of the phrase existing around the word. FIG. 8 shows an example in which “BP” existing immediately after “high” is extracted as a candidate for a synonymous term of “blood pressure” because the examination result is higher than the reference value. In this case, there may be a plurality of patterns of the word corresponding to the magnitude relationship of the examination result with respect to the reference value, such as “high”, “higher”, and “highest”. In addition, the word corresponding to the magnitude relationship of the examination result with respect to the reference value is not limited to “high”, and may be “low”, “large”, “small”, “many”, “few”, and the like.

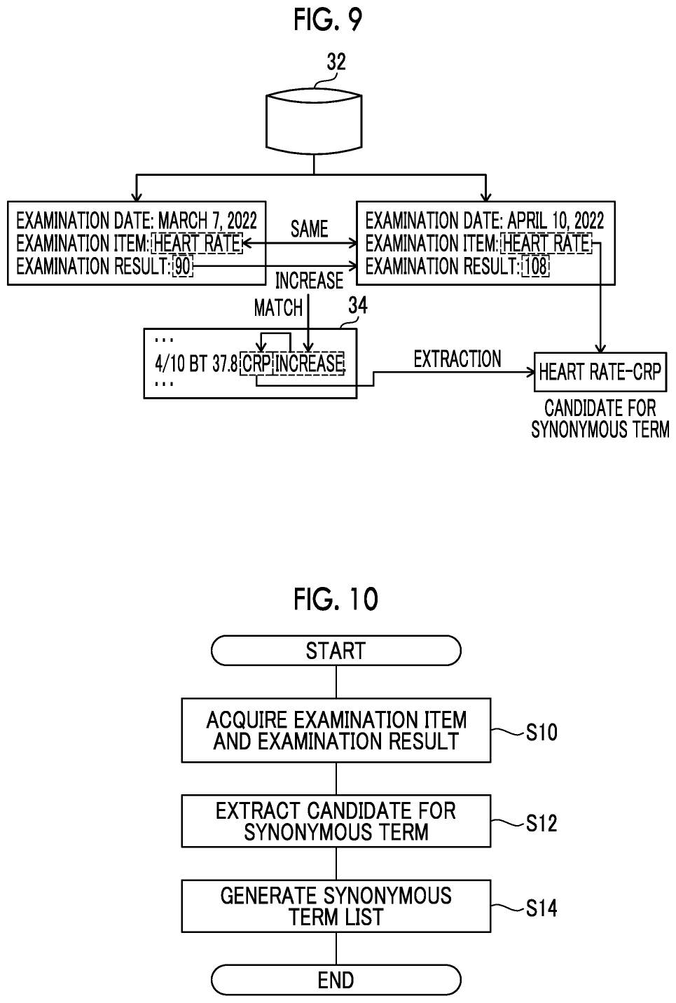

As shown in FIG. 9, in a case in which there are a plurality of the same examination items of the same patient in the examination result DB 32, the examination results are different from each other, and the word representing the difference between the plurality of examination results is included in the document data 34, the extraction unit 42 may extract the phrase existing around the word included in the document data 34. In addition, in this case, the statistical value of the word may further include the statistical value of the phrase existing around the word. FIG. 9 shows an example in which, since the first examination result is “90” and the second examination result is “108” for the examination item of “heart rate”, and the heart rate is increased, “CRP” existing immediately before “increase” is extracted as the candidate for the synonymous term of “heart rate”. The word representing the difference between the plurality of examination results is not limited to “increase”, and may be “decrease”, “reduction”, “decrement”, “rise”, and the like.

Hereinafter, actions of the information processing apparatus 10 will be described with reference to FIG. 10. The CPU 20 executes the information processing program 30, thereby executing processing of generating the synonymous term list shown in FIG. 10. The processing of generating the synonymous term list shown in FIG. 10 is executed, for example, in a case in which an instruction to start execution is input by the user.

In step S10 in FIG. 10, the acquisition unit 40 acquires the plurality of document data 34 from the storage unit 22 and acquires the examination item and the examination result which are associated with each other from the examination result DB 32. In step S12, as described above, in a case in which the examination result acquired in step S10 is included in the document data 34 acquired in step S10, the extraction unit 42 extracts the phrase existing around the examination result included in the document data 34 as the candidate for the synonymous term of the examination item.

In step S14, as described above, the generation unit 44 generates the synonymous term list from the candidates for the synonymous term based on the statistical value of the phrases extracted in step S12 in the examination result DB 32. In a case in which the processing of step S14 ends, the processing of generating the synonymous term list ends.

As described above, according to the present embodiment, it is possible to accurately extract the pair of synonymous terms.

It should be noted that, in the embodiment described above, for example, as a hardware structure of a processing unit that executes various types of processing such as each functional unit of the information processing apparatus 10, various processors shown below can be used. As described above, in addition to the CPU that is a general-purpose processor that executes software (program) to function as various processing units, the various processors include a programmable logic device (PLD) that is a processor of which a circuit configuration can be changed after manufacture, such as a field programmable gate array (FPGA), and a dedicated electric circuit that is a processor having a circuit configuration that is designed for exclusive use in order to execute specific processing, such as an application specific integrated circuit (ASIC).

One processing unit may be configured by using one of the various processors or may be configured by using a combination of two or more processors of the same type or different types (for example, a combination of a plurality of FPGAs or a combination of a CPU and an FPGA). Moreover, a plurality of processing units may be configured by using one processor.

A first example of the configuration in which the plurality of processing units are configured by using one processor is a form in which one processor is configured by using a combination of one or more CPUs and the software and this processor functions as the plurality of processing units, as represented by computers, such as a client and a server. A second example thereof is a form of using a processor that realizes the function of the entire system including the plurality of processing units by one integrated circuit (IC) chip, as represented by a system on chip (SoC) or the like. In this way, as the hardware structure, the various processing units are configured by using one or more of the various processors described above.

Further, the hardware structure of these various processors is, more specifically, an electric circuit (circuitry) in which circuit elements such as semiconductor elements are combined.

In addition, in the embodiment described above, an aspect has been described in which the information processing program 30 is stored (installed) in the storage unit 22 in advance, but the present disclosure is not limited to this. The information processing program 30 may be provided in a form of being recorded in a recording medium, such as a compact disc read only memory (CD-ROM), a digital versatile disc read only memory (DVD-ROM), and a universal serial bus (USB) memory. Moreover, the information processing program 30 may be provided in a form being downloaded from an external device via a network.

In regard to the embodiment described above, the following supplementary notes will be further disclosed.

### Supplementary Note 1

An information processing apparatus comprising: at least one processor, in which the processor acquires document data, and an item and a numerical value which are associated with each other, and extracts, in a case in which a second numerical value within an allowable range including an acquired first numerical value is included in the document data, a phrase existing around the second numerical value included in the document data as a candidate for a synonymous term of the item.

### Supplementary Note 2

The information processing apparatus according to supplementary note 1, in which the processor generates a synonymous term list from the candidates for the synonymous term based on a statistical value of the extracted phrase in accumulation data in which a plurality of sets of the items and the numerical values are accumulated.

### Supplementary Note 3

The information processing apparatus according to supplementary note 2, in which the statistical value is the number of times of appearance of the extracted phrase in the accumulation data, and the processor adds, to the synonymous term list, a phrase of which the statistical value is equal to or larger than a threshold value among the extracted phrases.

### Supplementary Note 4

The information processing apparatus according to supplementary note 2, in which the statistical value is the number of times of appearance of the extracted phrase in the accumulation data, and the processor adds, to the synonymous term list, a phrase of which the statistical value is relatively large among candidates for the extracted phrase.

### Supplementary Note 5

The information processing apparatus according to any one of supplementary notes 2 to 4, in which the processor acquires a reference value corresponding to the item, and extracts, in a case in which a word corresponding to a magnitude relationship of the acquired numerical value with respect to the reference value is included in the document data, a phrase existing around the word included in the document data, and the statistical value includes a statistical value of a phrase existing around the word in the accumulation data.

### Supplementary Note 6

The information processing apparatus according to any one of supplementary notes 1 to 5, in which the processor performs weighting by setting a weight coefficient of a statistical value of a phrase extracted by applying a unit in the numerical value and including the second numerical value and the unit in the document data to a value larger than a weight coefficient of a statistical value of a phrase extracted by including only the second numerical value in the document data.

### Supplementary Note 7

The information processing apparatus according to any one of supplementary notes 1 to 6, in which the processor extracts, in a case in which the phrase existing around the second numerical value is extracted, a plurality of phrases having different lengths or positions as the candidates for the synonymous term.

### Supplementary Note 8

The information processing apparatus according to any one of supplementary notes 2 to 5, in which the processor performs weighting of the statistical value of the phrase based on a statistical value of the acquired numerical value in the accumulation data.

### Supplementary Note 9

The information processing apparatus according to any one of supplementary notes 2 to 5, in which the processor derives a degree of similarity between the acquired item and the extracted phrase, and performs weighting by setting a weight coefficient of the statistical value of the phrase of which the degree of similarity is equal to or larger than a certain value to a value larger than a weight coefficient of the statistical value of the phrase of which the degree of similarity is smaller than the certain value.

### Supplementary Note 10

An information processing method including: via a processor provided in an information processing apparatus, acquiring document data, and an item and a numerical value which are associated with each other; and extracting, in a case in which a second numerical value within an allowable range including an acquired first numerical value is included in the document data, a phrase existing around the second numerical value included in the document data as a candidate for a synonymous term of the item.

### Supplementary Note 11

An information processing program for causing a processor provided in an information processing apparatus to execute a process including: acquiring document data, and an item and a numerical value which are associated with each other; and extracting, in a case in which a second numerical value within an allowable range including an acquired first numerical value is included in the document data, a phrase existing around the second numerical value included in the document data as a candidate for a synonymous term of the item.

What is claimed is:

1. An information processing apparatus comprising:
at least one processor,
wherein the processor
acquires document data, and an item and a numerical value which are associated with each other, and
extracts, in a case in which a second numerical value within an allowable range including an acquired first numerical value is included in the document data, a phrase existing around the second numerical value included in the document data as a candidate for a synonymous term of the item.

2. The information processing apparatus according to claim 1,
wherein the processor generates a synonymous term list from the candidates for the synonymous term based on a statistical value of the extracted phrase in accumulation data in which a plurality of sets of the items and the numerical values are accumulated.

3. The information processing apparatus according to claim 2,
wherein the statistical value is the number of times of appearance of the extracted phrase in the accumulation data, and
the processor adds, to the synonymous term list, a phrase of which the statistical value is equal to or larger than a threshold value among the extracted phrases.

4. The information processing apparatus according to claim 2,
wherein the statistical value is the number of times of appearance of the extracted phrase in the accumulation data, and
the processor adds, to the synonymous term list, a phrase of which the statistical value is relatively large among candidates for the extracted phrase.

5. The information processing apparatus according to claim 2,
wherein the processor
acquires a reference value corresponding to the item, and
extracts, in a case in which a word corresponding to a magnitude relationship of the acquired numerical value with respect to the reference value is included in the document data, a phrase existing around the word included in the document data, and
the statistical value includes a statistical value of a phrase existing around the word in the accumulation data.

6. The information processing apparatus according to claim 1,
wherein the processor performs weighting by setting a weight coefficient of a statistical value of a phrase extracted by applying a unit in the numerical value and including the second numerical value and the unit in the document data to a value larger than a weight coefficient of a statistical value of a phrase extracted by including only the second numerical value in the document data.

7. The information processing apparatus according to claim 1,
wherein the processor extracts, in a case in which the phrase existing around the second numerical value is extracted, a plurality of phrases having different lengths or positions as the candidates for the synonymous term.

8. The information processing apparatus according to claim 2,
wherein the processor performs weighting of the statistical value of the phrase based on a statistical value of the acquired numerical value in the accumulation data.

9. The information processing apparatus according to claim 2,
wherein the processor
derives a degree of similarity between the acquired item and the extracted phrase, and
performs weighting by setting a weight coefficient of the statistical value of the phrase of which the degree of similarity is equal to or larger than a certain value to a value larger than a weight coefficient of the statistical value of the phrase of which the degree of similarity is smaller than the certain value.

10. An information processing method comprising:
via a processor provided in an information processing apparatus,
acquiring document data, and an item and a numerical value which are associated with each other; and
extracting, in a case in which a second numerical value within an allowable range including an acquired first numerical value is included in the document data, a phrase existing around the second numerical value included in the document data as a candidate for a synonymous term of the item.

11. A non-transitory computer-readable storage medium storing an information processing program for causing a processor provided in an information processing apparatus to execute a process comprising:
acquiring document data, and an item and a numerical value which are associated with each other; and
extracting, in a case in which a second numerical value within an allowable range including an acquired first numerical value is included in the document data, a phrase existing around the second numerical value included in the document data as a candidate for a synonymous term of the item.
